(19) United States
(12) Patent Application Publication
(10) Pub. No.: US 2016/0221069 A1
(43) Pub. Date: Aug. 4, 2016

(54) RIVET ELEMENT

(71) Applicant: PROFIL VERBINDUNGSTECHNIK GmbH & CO. KG, Friedrichsdorf (DE)

(72) Inventors: Oliver Diehl, Bad Homburg v.d.H. (DE); Richard Humpert, Bad Nauheim (DE); Andreas Lembach, Darmstadt (DE)

(21) Appl. No.: 15/021,449

(22) PCT Filed: Aug. 7, 2014
(86) PCT No.: PCT/EP2014/066973

§ 371 Date: Mar. 11, 2016

(30) Foreign Application Priority Data
Sep. 17, 2013 (DE) 10 2013 218 605.3

(51) Int. Cl. B21J 15/02; B29C 65/00; B29C 65/60; F16B 19/08; F16B 37/06

(52) U.S. Cl. CPC B21J 15/025; F16B 19/086; F16B 37/065; F16B 37/068; B29C 65/60; B29C 66/30321; B29C 66/474; B29C 66/721; B29K 2715/00; B29K 2701/12

(57) ABSTRACT

The invention relates to a rivet element for attachment to a component, in particular to a component of a fiber composite material. The rivet element has a flange section which in the installed state contacts the component and a rivet section. The rivet section has a tip which converges in a direction away from the flange section with a dilated end portion being provided at the end of the tip remote from the flange section.

The invention relates to a rivet element for attachment to a component, in particular to a component of a fiber composite material, to a component assembly of a corresponding rivet element and a component and also to a method for the attachment of the rivet element to a component and to a method for manufacture of a rivet element.

For the attachment of fastener elements, such as in particular rivet elements to components of sheet metal or of fiber composite material one previously assume that it is necessary to form an opening in the component for the fastener element in preparation for the attachment process. For components of fiber composite materials in particular a procedure of this kind is however associated with considerable disadvantages, since discontinuities arise through the openings in the material which considerably weaken the material and particularly at positions where a particularly high material strength is required for the reliable anchorage of the fastener elements.

The object of the invention is thus to provide a possibility for attaching rivet elements to components in which the components do not have to be weakened in disadvantageous manner, with it in particular being possible to attach fastener elements to components of fiber composite materials.

This object is satisfied by the invention by a rivet element having the features of claim 1, by a component assembly having the features of claim 10 and by a method having the features of claims 11 and 12.

The rivet element in accordance with the invention has a flange section which contacts the component in the installed state and a rivet section. The rivet section includes a tip which converges in a direction away from the flange section with a diverging end portion being provided at the end of the tip remote from the flange section.

Through the formation of the rivet section as a tapering tip it is possible to first press the tip of the element into the respective material. The divergence of the end section at the end of the tip adjacent the component ensures that on pressing the rivet section into the component, the tip experiences a progressive dilation through the cooperation with the material of the component which, in the further course of the pressing in process, also includes the tip. Thus, on pressing in of the rivet section it undergoes a progressive deformation for the formation of a rivet connection. The dilated end portion thus reliably ensures that the reshaping of the rivet section takes place in a controlled manner, namely in such a way that the rivet section is beaded over outwardly.

For components which are manufactured from a material which enables such a pressing in of the rivet section, at least in specific states, one can dispense with the manufacturing of an opening for the rivet element. The rivet element in accordance with the invention is consequently especially suited for components of fiber composite materials which are at least temporarily in a state in which the material is efficiently soft or “pasty”. This will be discussed further in the following. Basically, the rivet elements in accordance with the invention can be used in conjunction with duroplastic or thermoplastic materials or components.

A further advantage of the invention lies in the fact that it is not essential to adhesively bond the fastener element to the component. An adhesive bond can however naturally also be additionally provided.

In accordance with an advantageous embodiment of the rivet element a restriction forming a waist is present between the end portion and the converging tip. I.e. the dilation of the end portion is executed in such a way that a minimum external circumference of the rivet section is not present at its free end but rather between the tip and the free end of the end portion, which ultimately also defines the free end of the rivet section. In particular, the end portion diverges at least regionally in the direction away from the flange portion.

The rivet section can include a plurality of segments which are in particular of tongue-like shape, are preferably connected to one another and which, on dilation of the rivet section during the installation of the rivet element, can be moved apart from one another in order to manufacture a rivet connection. In particular, the segments become narrower in each case along a central axis in the direction away from the flange section. At the interconnection points the segments can each have an intentional material weakness in the manner of a point of intended fracture, for example by a lower wall thickness. The dilation of the tip is in this case associated with a breaking open of the tip in order to move the segments apart from one another. Alternatively, the segments can be not connected together, at least regionally, and thus either lie in contact with one another or are slightly spaced from one another, so that in the initial state they jointly form a tip serving for the pressing of the rivet element into the component and can subsequently be moved apart from one another without breaking open of material. For example, the rivet section includes a plurality of in particular tongue-like segments which jointly form the tip and which can be moved apart during the dilation of the tip.

In accordance with a simple embodiment of the rivet element of the invention which is efficient to manufacture the rivet section is formed by reshaping it from the originally hollow cylindrical base body. I.e. the base body is reshaped in the course of manufacturing process of the rivet element to form a tip. In doing this the material of the base body can undergo folding, so that the tips which are produced during the reshaping process have the contour of a flower or a rosette in a cross-section perpendicular to the longitudinal axis of the rivet element. Basically, the end portion can also be shaped during the reshaping process. However, this preferably takes place in a separate step.

The rivet section can have a substantially cylindrical portion which is adjoined by the tip. The cylindrical portion is in particular arranged between the flange section and the tip.

In order to be able to dispense with an adhesive bonding of the rivet element to the component and/or to achieve a particularly reliable fixation of the element the flange section can be provided with means for providing security against rotation. These means are, for example, recesses and/or ribs which extend in the radial direction.

The rivet elements in accordance with the invention can be formed as a nut element or as a bolt element.

The invention furthermore relates to a component assembly consisting of a rivet element in accordance with at least one of the previously described embodiments and a component, in particular a component of fiber composite material.

In a method in accordance with the invention for the attachment of a rivet element in accordance with at least one of the above-described embodiments to a component, in particular to a component of fiber composite material, the rivet element is pressed into a non-prepared component, in particular into a component which is not provided with an opening for the element. The component thereby lies, at least in the region into which the rivet element is introduced, on a substantially planar support surface or base. In other words, in this method no die button is required. The reshaping of the rivet section for the formation of the rivet connection which fixes the rivet elements of a component takes place, as already explained, automatically as a result of the design of the end portion of the rivet section. Ultimately a planar surface functions as a “die button” which leads to considerable cost savings.

In a method in accordance with the invention for the manufacture of a rivet element in accordance with at least one of the above-described embodiments, the end section is shaped in that a spike is pressed into the end remote from the flange section of a pre-shaped tip provided at the rivet section. This therefore takes place before the rivet element is secured to a component. The pre-shaped tip is thus the “precursor” of the end portion formed on the finished rivet element.

In accordance with a preferred embodiment the method of manufacture the pre-shaped tip is formed at least regionally by reshaping a hollow cylindrical base body at least once as was already described above. The end portion is subsequently generated by pressing the spike into the free end of the pre-shaped tip. Basically it is however also possible to form the end portion during the reshaping process of the base body.

In order to facilitate this, provision can be made for the tip to have an insertion aid for the spike, in particular of funnel-like shape.

The spike is in particular made substantially in the shape of a right cone.

The invention can advantageously be used both in connection with fiber composite materials with relative short fibers as well as with materials with relatively long fibers. Components with short fibers can be manufactured in an injection molding process. In this connection the material mixture is readily deformable so that the tools which are used during the manufacture of these components can simultaneously be exploited for the attachment of rivet elements. With many plastic materials it is then possible, in similar manner to the deep-drawing of sheet metal parts, to press the parts by the introduction of heat and by means of a tool into a specific shape. The presses that are used for this can simultaneously be used for the introduction of the rivet element into the adequately soft composite material.

In both cases, both with short fiber and also with long fiber material the circumstance is exploited that the rivet element in accordance with the invention can be pressed into the material which is adequately soft at least for a time as a result of the process.

Preferred further developments of the invention are also set forth in the dependent claims, in the description and in the drawings.

The invention will now be explained in the following purely by way of example with reference to an advantageous embodiment and to the drawings. In which are shown:

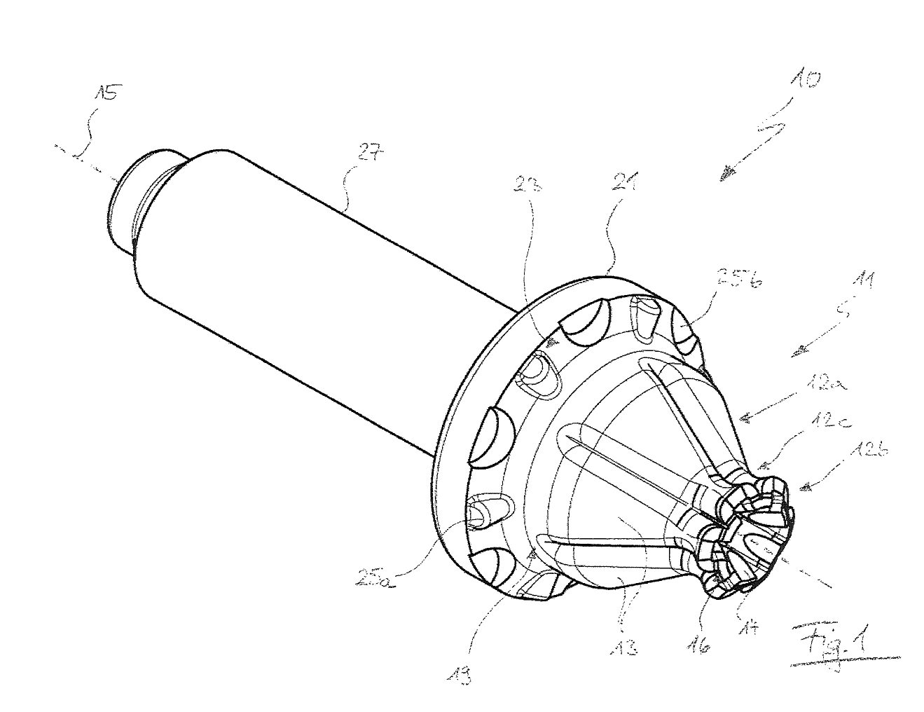

FIG. 1 a perspective view of an embodiment of the rivet element of the invention,

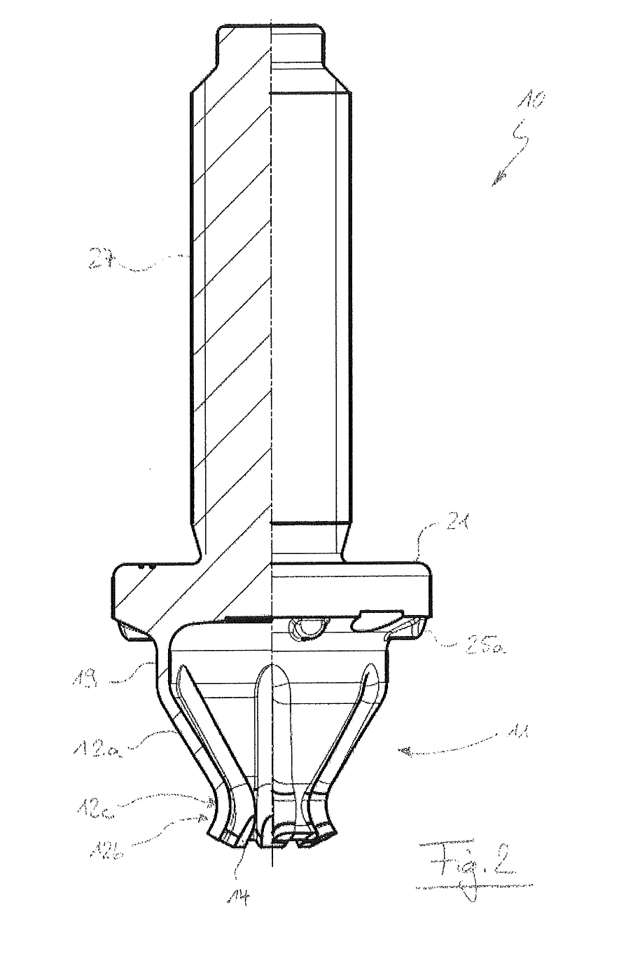

FIG. 2 a partly sectioned side view of the rivet element in accordance with FIG. 1,

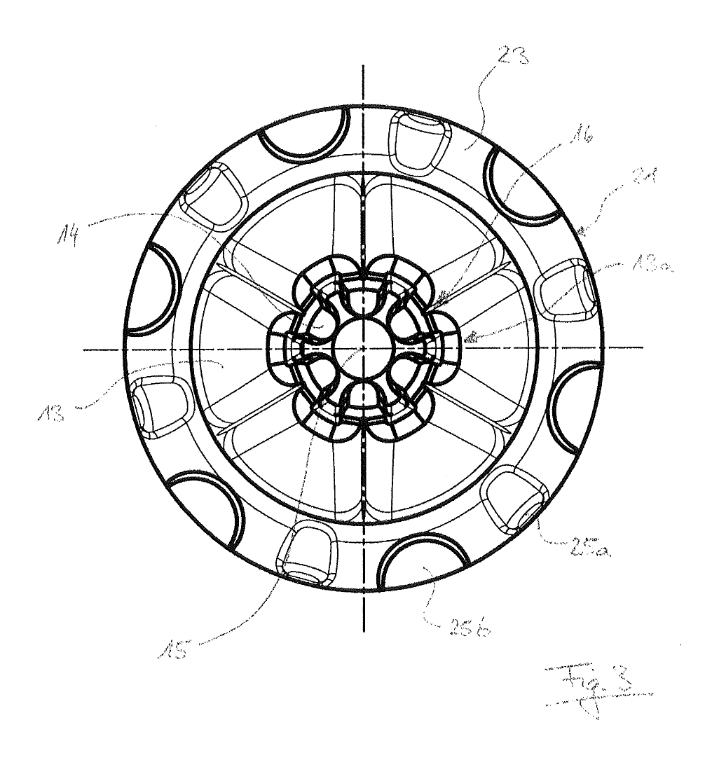

FIG. 3 an end view of the rivet element in accordance with FIG. 1,

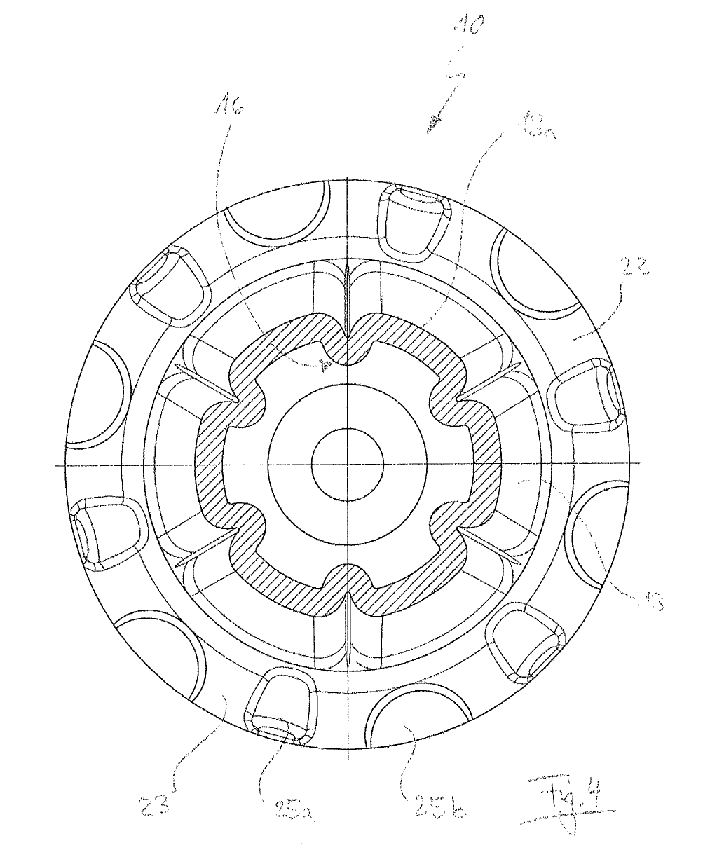

FIG. 4 a sectional view of the rivet element in accordance with FIG. 1 in a plane perpendicular to the longitudinal axis which intersects the rivet section,

FIG. 5 a side view of the rivet element of FIG. 1 before the dilated end portion is formed,

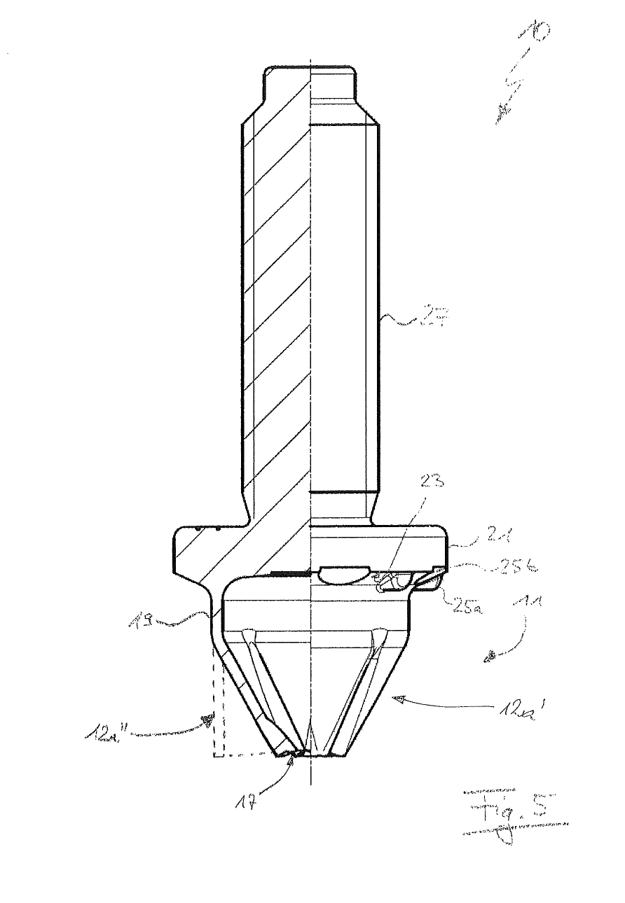

FIG. 6 a side view of the rivet element in accordance with FIG. 1 after the dilated end portion has been formed with the aid of a spike,

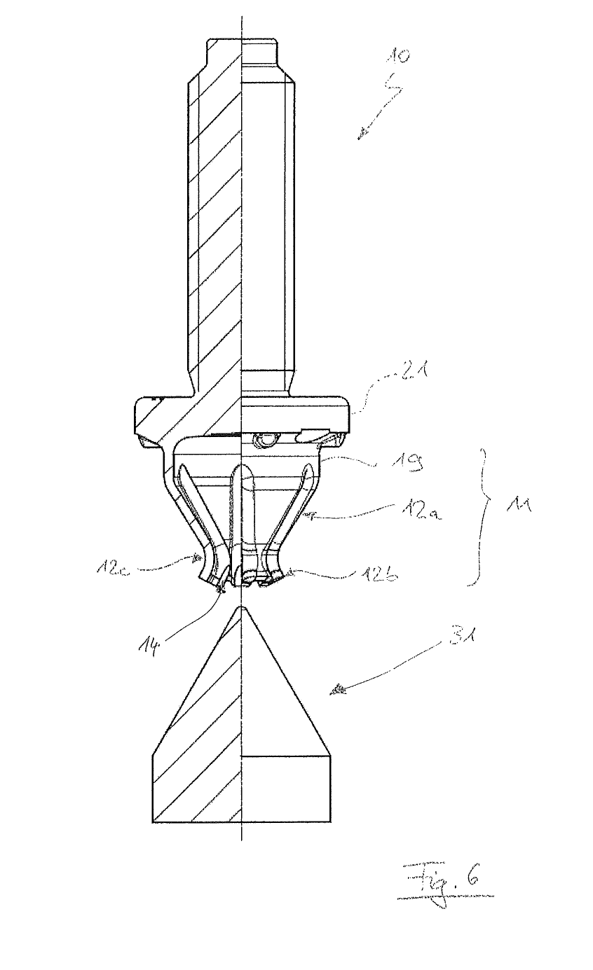

FIG. 7 a rivet element in accordance with FIG. 1 shortly before the penetration into the component,

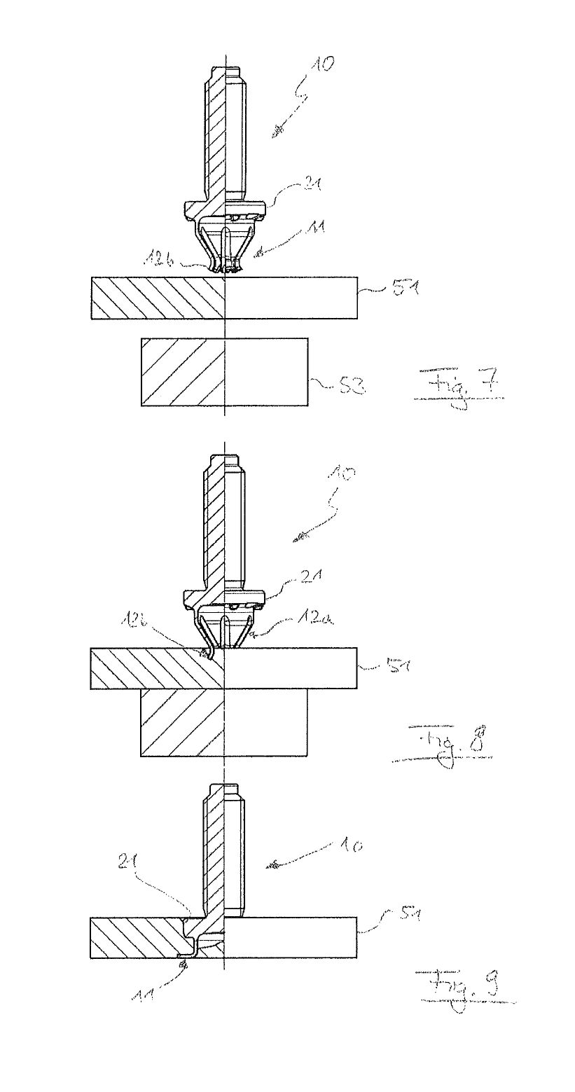

FIG. 8 a rivet element in accordance with FIG. 1 shortly after the penetration into the component, and

FIG. 9 the rivet element in accordance with FIG. 1 in a state fixed to the component.

FIG. 1 shows an embodiment 10 of a rivet element in accordance with the invention. The rivet element 10 includes a flange section 21 which extends radially with respect to a central axis 15 of the element. A fastener portion 27 which can, for example, be provided with an external thread, extends in the axial direction from a side of the flange section 21 remote from the component in the installed state.

In this embodiment the rivet element 10 is consequently formed as a bolt element. This is however not essential. In an alternative embodiment the rivet element in accordance with the invention can, for example, also be formed as a nut element which has a bore or an opening provided with an internal thread as the fastening portion.

The lower side of the flange section 21 remote from the fastener portion 27 serves as a contact surface 23 for a component 51 (see in particular FIG. 9) to which the rivet element 10 is to be attached. The contact surface 23 is provided with a plurality of recesses 25b and projecting ribs 25a which extend in the radial direction and which serve as a security against rotation.

A rivet section 11 extends in the axial direction from the side of the flange portion 21 remote from the fastener portion 27. Starting from the flange section 21 the rivet section 11 first has a short substantially cylindrical portion 19 which merges into a tip 12a. The tip 12a tapers or converges in a direction away from the flange section 21. At the end of the tip 12a remote from the flange section 21 an end portion 12b is provided which, in contrast to the tip 12a, has a divergent shape. A restriction 12c of the rivet section 11 is present between the tip 12a and the end portion 12b. Here the outer diameter of the rivet section 11 is minimal so that a waist is formed. The waisting of the rivet section 11 is, in the present embodiment, comparatively pronounced. The rivet section 11 can in certain cases admittedly be even more pronouncedly waisted. As a rule however a less pronounced restriction is sufficient in order to achieve the desired effect. It is indeed also possible for the end portion 12b to have an only slightly diverging almost coaxial design, since a slight dilation of the end portion 12b ultimately also leads to an outward bending of the rivet section 11 on being pressed into the component 51.

The rivet section 11 is formed by a plurality of tongue-like segments 13 which extend from the flange section 21 and form the converging tip 12a of the rivet section in the manner of a closed bud, with the end portion 12b—pictorially described—indicating an opening of the bud. The four segments 13 in this embodiment—more than four or less than four segments could also be provided—are consequently formed in such a way that they become narrower along the middle axis 15 starting from the flange section 12.

The walls of radially inwardly projecting bends 16 of the connections between the segments 13 have contact surfaces 14—as will be explained in more detail in the following—which arise during the dilation of the end portion 12b.

The rivet section 11 of the rivet element 10 makes it possible to press the rivet element 10 into a sufficiently soft component to which the rivet element 10 is to be attached without it being necessary to form an opening for the rivet element 10 in the component in a preparatory step.

FIG. 2 shows a partly sectioned view of the rivet element 10 in accordance with FIG. 1 in order to make clear the shaping of the tip 12a converging in the axial direction and the dilation of the end portion 12b.

FIG. 3 shows a side view of the rivet element 10. It can be seen that the rivet section 12 is produced by folding so that the rosette-like contour of the end portion 12b and of the tip 12a results. The comparatively straight contour sections 13a in the regions of the segment 13 are connected to one another by radially inwardly projecting bends. The bends 16 define, in a three-dimensional consideration, valleys the beds of which approach the central axis 15 in the region of the tip 12a with an increasing distance from the flange section 21.

FIG. 4 shows, by way of clarification of this shape, a section through the rivet section 11 above the restriction 12c.

FIG. 5 shows an intermediate state of the rivet element 16 during its manufacture. In a basic state the rivet element 10 has a hollow cylindrical base body 12a″ which projects away from the flange section 21 as is indicated in broken lines in the left part of the drawing. The pre-shaped tip 12a′ is formed by reshaping of the base body 12a″. Through the shaping process a funnel-like introduction aid 17 for a spike 31 (see FIG. 6) formed in the pre-shape tip 12a′ serves for the dilation of the pre-shaped tip 12a′.

FIG. 6 shows the finished rivet element 10 after the end portion 12b has been formed by pressing of the spike 31 into the pre-shaped tip 12a′. In this connection the contact surfaces 14 have arisen at the inner sides of the folds 16. The gradient of the flanks of the spike and its depth of penetration into the pre-shaped tip 12a′ determine the degree of dilation of the end portion 12b.

A possible sequence for the attachment of the rivet element 10 in accordance with the invention to component 51 is shown in FIGS. 7 to 9.

FIG. 7 shows the planar support 53 which serves as a support surface for the component 51 during the pressing in of the rivet element. In contrast to customary processes no die button is required to bring about the beading over of the rivet section 11.

As can be seen in FIG. 8 the end portion 12b first penetrates into the component 51. As a result of the dilated shape of the end portion 12b this if further spread apart by the material of the component 51 which penetrates into the interior of the rivet section 11. The material is thereby plastically deformed or indeed partly “formed into crumbs”.

In the further course of the pressing in process, the free end of the rivet section 11, which is in the process of being spread apart, enters into contact with the planar support 53. In this way, the section 11 is now fully beaded over until the end state shown in FIG. 9 results. It can be seen that the rivet element 10 has been pressed so far into the component 51 that the flange section 21 does not project out of the component in the axial direction, but rather terminates flush with its surface.

The degree of dilation of the end portion 12b suitable for the specific application—i.e. its depth in the axial direction and its width defined by the gradient of the flanks of the spike—depends, amongst other things, on the material and the thickness of the component, on the mechanical characteristics of the rivet section 11 and on the pressing in forces/pressing in speeds. Surprisingly, the dilation of the end portion 12b does not lead to an uncontrolled reshaping of the rivet section 11 but rather initiates—with a suitable matching of the above named parameters—to the dilation of the rivet section 11 which is subsequently bent over, by the cooperation with the planar support surface 53 in order to complete the rivet connection.

The degree of the dilation is to be selected such that on the one hand it is not to large. Then the rivet section 11 would possibly spread too quickly and can eventually not penetrate fully into the component 51. On the other hand the dilation may not be too small because otherwise it cannot be reliably ensured that the spreading of the rivet section 11 takes place sufficiently quickly. It has however been shown that often a comparatively small dilation of the end portion 12b leads to the desired reshaping of the rivet section 11 when it is pressed into the component 51.

The above described manufacturing process is assisted when the material is at least temporarily heated and thus becomes softer, so that the rivet element 10 can be more easily pressed into the material.

The invention thus makes it possible to attach rivet elements into components of fiber composite materials which are also termed “organic sheet metals” without having to form openings for the rivet elements in the material. Disadvantageous weakening of the material is hereby avoided in advantageous manner.

### REFERENCE NUMERAL LIST

10 rivet element
11 rivet section
12a tip
12a′ pre-shaped tip
12a″ base body
12b end portion
12c restriction
13 segment
13a contour section
14 contact surface
15 central axis
16 bend
17 introduction aid
19 cylindrical portion
21 flange section
23 contact surface
25a, 25b means for providing security against rotation (rib and recess)
27 fastener portion
31 spike
51 component
53 support surface/base

1-15. (canceled)

16. A rivet element for attachment to a component (51), in particular to a component of a fiber composite material, wherein the rivet element has a flange section (21) which in the installed state contacts the component (51) and a rivet section (11), wherein the rivet section (11) has a tip (12A) which converges in a direction away from the flange section (21) with a dilated end portion (12B) being provided at the end of the tip remote from the flange section (21).

17. A rivet element in accordance with claim 16, wherein a restriction (12c) forming a waist is provided between the end portion (12b) and the converging tip (12a).

18. A rivet element in accordance with claim 16, wherein the end portion (12b) diverges at least regionally in the direction away from the flange section (21).

19. A rivet element in accordance with claim 16, in which the rivet section (11) has a plurality of in particular tongue-like segments (13) which are preferably connected to one another and which can be moved apart from one another during the dilation of the rivet section (11) during the installation of the rivet element.

20. A rivet element in accordance with claim 19, wherein the segments (13) each become narrower along a central axis (15) in the direction away from the flange section (21).

21. A rivet element in accordance with claim 16, wherein the rivet section (11) is formed by reshaping an originally hollow cylindrical base body.

22. A rivet element in accordance with claim 16, wherein the rivet section (11) has an at least substantially cylindrical section (19) to which the rip (12a) is adjoined.

23. A rivet element in accordance with claim 16, wherein the flange section (21) is provided with means (25) for providing security against rotation, in particular with projecting ribs (25a) and/or recesses (25b).

24. A rivet element in accordance with claim 16, wherein it is formed as a nut element or as a bolt element.

25. A component assembly comprising a rivet element in accordance with claim 1 and a component (51), in particular a component of a fiber composite material.

26. A method for attaching a rivet element, in accordance with claim 16 to a component (51), wherein the rivet element is pressed into an unprepared component (51) which is not provided with an opening for the rivet element, the component lying on an at least substantially planar support surface at least in the region in which the rivet element is attached.

27. A method for the manufacture of a rivet element in accordance with claim 16, wherein the end section (12b) is shaped by pressing a spike (31) into the end remote from the flange section (21) of a pre-shaped tip (12a′) provided at the flange section (21).

28. A method in accordance with claim 27, wherein the pre-shaped tip (12a′) is formed by at least regional deformation, at least once, of a hollow cylindrical base body (12a″).

29. A method in accordance with claim 27, wherein the pre-shaped tip (12a′) has an funnel-like insertion aid (17) for the spike (31).

30. A method in accordance with claim 27, wherein the spike (31) has essentially the shape of a right circular cone.

31. A method in accordance with claim 26, wherein the component is a fiber reinforced plastic component.
